(19) United States
(12) Patent Application Publication
(10) Pub. No.: US 2023/0327477 A1
(43) Pub. Date: Oct. 12, 2023

(54) MODULAR AND PORTABLE SOLAR-POWERED CHARGING DEVICES

(71) Applicant: MPOWERD, Inc., Brooklyn, NY (US)

(72) Inventors: John Salzinger, Brooklyn, NY (US); Seungah Jeong, New York, NY (US); Scott Klimcke, Brooklyn, NY (US)

(73) Assignee: MPOWERD, Inc., Brooklyn, NY (US)

(21) Appl. No.: 18/133,729

(22) Filed: Apr. 12, 2023

Related U.S. Application Data
(60) Provisional application No. 63/330,195, filed on Apr. 12, 2022.

(51) Int. Cl. H02J 7/35; H02J 7/00; H02J 50/10; H02J 50/40; H02S 10/20; H02S 10/40; H01M 10/46

(52) U.S. Cl. CPC H02J 7/35; H02J 7/0042; H02J 50/10; H01M 10/465; H02S 10/20; H02S 10/40; H02J 50/402

(57) ABSTRACT

Modular and portable solar-powered charging devices are described. The solar-powered device may include a housing, a rechargeable battery disposed within the housing, and a solar panel positioned along an exterior of the housing. The solar panel is electrically connected to the rechargeable battery. The solar-powered charging device is configured to transfer electrical power generated by the solar panel and stored in the rechargeable battery to a second solar-powered charging device when the housing is positioned adjacent to the second solar-powered charging device.

### CROSS-REFERENCE TO RELATED APPLICATION

This application claims the benefit of U.S. Provisional Application No. 63/330,195, filed Apr. 12, 2022, which is hereby incorporated by reference.

### TECHNICAL FIELD

The present invention relates to portable solar-powered charging devices for electronic devices. More particularly, the present invention relates to a portable solar-powered charging device that is modular for assembly in numerous configurations for a variety of uses.

### BACKGROUND

Portable electronic chargers have uses in a variety of situations, including during travel and in situations of limited or no power access. Examples include cases of natural disaster and other emergencies, remote or rural locations far from a conventional power outlet or electricity grid, and developing countries that have limited and/or unreliable power. Yet, current portable electronic chargers require connection to a power outlet for charging prior to being capable of charging other electronic devices. However, in outdoor environments, users may not have access to conventional power outlets. A portable electronic device connected to an electrical outlet is not portable until the charging is complete, or at least until the battery is charged to some degree.

### SUMMARY

The present disclosure includes a solar-powered charging device capable of being assembled in a variety of configurations for different uses. The solar-powered charging device herein may be useful in situations of intermittent access to electricity as a more stable and/or consistent source of power. The solar-powered charging device herein also may be more economical and/or portable than traditional charging devices.

According to at least one example, a solar-powered charging device includes a housing; a rechargeable battery disposed within the housing; and a solar panel positioned along an exterior of the housing, the solar panel is electrically connected to the rechargeable battery; wherein the solar panel is configured to generate electrical power and the rechargeable battery is configured to store the generated electrical power to charge an external electronic device electrically connected to the device.

Any of the solar-powered charging devices described herein may include any of the following features. The device is configured to wirelessly transfer electrical power generated by the solar panel and stored in the rechargeable battery to a second solar-powered charging device when the housing is positioned adjacent to the second solar-powered charging device. Further including one or more first induction coils disposed within the housing, and one or more second induction coils disposed within a second housing of the second solar-powered charging device. The electrical power is transferred from the one or more first induction coils as a current and received by the one or more second induction coils. Further including an engagement mechanism disposed within or coupled to the housing, the engagement mechanism is configured to attach the housing to a second housing of the second solar-powered charging device. The second solar-powered charging device includes a complementary engagement mechanism disposed within or coupled to the second housing, the engagement mechanism of the device is configured to mate with the complementary engagement mechanism of the second solar-powered charging device to attach the housing to the second housing. The engagement mechanism includes at least a first magnet, and the complementary engagement mechanism includes at least a second magnet that is configured to magnetically couple with the first magnet when the second housing is positioned adjacent to the housing. The solar-powered charging device and the second solar-powered charging device are cooperatively configured to generate an electric power grid for charging one or more external electronic devices coupled to the solar-powered charging device and the second solar-powered charging device. The electric power grid is selectively modular such that the housing of the solar-powered charging device and the second housing of the second solar-powered charging device are cooperatively configured to couple with one another in a plurality of configurations. The plurality of configurations includes at least a first configuration with the housing of the solar-powered charging device positioned over the second housing of the second solar-powered charging device; a second configuration with the housing of the solar-powered charging device positioned lateral to the second housing of the second solar-powered charging device; and a third configuration with the housing of the solar-powered charging device positioned relative the second housing of the second solar-powered charging device to form a three-dimensional arrangement. Further including an electrical connector disposed within the housing, the electrical connector is electrically connected to the rechargeable battery, and configured to electrically connect the rechargeable battery to an external electronic device. The device is configured to charge the external electronic device via the electrical connector using the electrical power generated by the solar panel and stored in the rechargeable battery. The device is configured to charge the rechargeable battery with electrical power from the external electronic device electrically connected thereto via the electrical connector. The electrical connector is a first electrical connector, and the housing includes a plurality of electrical connectors disposed within the housing and electrically connected to the rechargeable battery, each of the plurality of electrical connectors is configured to receive a different electrical input. The device is configured to charge a plurality of external electronic devices electrically connected to the rechargeable battery via the plurality of electrical connectors. The device is configured to charge the rechargeable battery with electrical power from one or more of the plurality of external electronic devices electrically connected thereto via one of the corresponding plurality of electrical connectors. The solar panel is expandable from a first position to a second position, and has a greater surface area when in the second position relative to the first position.

According to another example, a solar-powered charging device includes a housing; a rechargeable battery disposed within the housing; and a solar panel positioned along an exterior of the housing, the solar panel is electrically connected to the rechargeable battery; wherein the device is configured to transfer electrical power generated by the solar panel and stored in the rechargeable battery to a second solar-powered charging device when the housing is positioned adjacent to the second solar-powered charging device.

Any of the solar-powered charging devices described herein may include any of the following features. The device is configured to wirelessly transfer electrical power generated by the solar panel and stored in the rechargeable battery to the second solar-powered charging device via one or more induction coils disposed within the housing. Further including an engagement mechanism disposed within or coupled to the housing, the engagement mechanism is configured to attach the housing to a second housing of the second solar-powered charging device. The second solar-powered charging device includes a complementary engagement mechanism disposed within or coupled to the second housing, the engagement mechanism of the device is configured to mate with the complementary engagement mechanism of the second solar-powered charging device to attach the housing to the second housing.

According to another example, a solar-powered charging assembly includes a first device including a first rechargeable battery; and a first solar panel electrically connected to the first rechargeable battery; and a second device including a second rechargeable battery; and a second solar panel electrically connected to the first rechargeable battery; wherein the first device is configured to transfer electrical power generated by the first solar panel and stored in the first rechargeable battery to the second rechargeable battery when the first device is positioned adjacent to the second device.

### BRIEF DESCRIPTION OF THE DRAWINGS

The accompanying drawings, which are incorporated in and constitute a part of the specification, are illustrative of one or more embodiments and, together with the description, explain the embodiments. The accompanying drawings have not necessarily been drawn to scale. Further, any values or dimensions in the accompanying drawings are for illustration purposes only and may or may not represent actual or preferred values or dimensions. Where applicable, some or all select features may not be illustrated to assist in the description and understanding of underlying features.

FIGS. 1A and 1B show perspective views of an exemplary solar-powered charging device, in accordance with some aspects of the present disclosure.

FIG. 2 shows a top view of the solar-powered charging device of FIGS. 1A-1B, in accordance with some aspects of the present disclosure.

FIGS. 3A-3C show side views of the solar-powered charging device of FIGS. 1A-1B, in accordance with some aspects of the present disclosure.

FIG. 4 shows a bottom view of the solar-powered charging device of FIGS. 1A-1B, in accordance with some aspects of the present disclosure.

FIG. 5 shows an exploded view of the solar-powered charging device of FIGS. 1A-1B, in accordance with some aspects of the present disclosure.

FIG. 6A shows a perspective view of a plurality of solar-powered charging devices of FIGS. 1A-1B coupled together in a first assembled configuration, in accordance with some aspects of the present disclosure.

FIG. 6B shows a perspective view of a plurality of solar-powered charging devices of FIGS. 1A-1B coupled together in a second assembled configuration, in accordance with some aspects of the present disclosure.

FIG. 7 shows another exemplary solar-powered charging device electrically coupled to an external device, in accordance with some aspects of the present disclosure.

FIG. 8 shows another exemplary solar-powered charging device electrically coupled to an external device, in accordance with some aspects of the present disclosure.

FIG. 9A shows a front view of an exemplary solar-powered charging device, in accordance with some aspects of the present disclosure.

FIG. 9B shows a rear view of the solar-powered charging device of FIG. 9A, in accordance with some aspects of the present disclosure.

FIG. 9C shows a bottom view of the solar-powered charging device of FIG. 9A, in accordance with some aspects of the present disclosure.

### DETAILED DESCRIPTION

The terminology used in this disclosure may be interpreted in its broadest reasonable manner, even though it is being used in conjunction with a detailed description of certain specific examples of the present disclosure. Both the foregoing general description and the following detailed description are exemplary and explanatory only and are not restrictive of the features, as claimed.

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass±5% of a specified amount or value. The terms “comprises,” “comprising,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. The term “exemplary” is used in the sense of “example” rather than “ideal.”

The present disclosure includes solar-powered charging devices that are portable and adapted to assume different configurations for varying uses (e.g., modular). For example, the solar-powered charging devices herein may include multiple components capable of assembly in a variety of modular configurations, e.g., for use in different types of environments or settings.

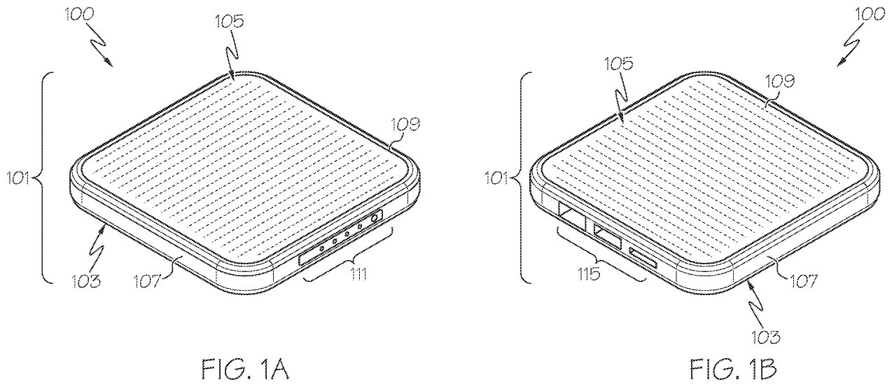

FIGS. 1A-1B show an exemplary solar-powered charging device 100 in accordance with the present disclosure. Solar-powered charging device 100 may include a plurality of components or mechanisms that may facilitate selective connection and charging between multiple solar-powered charging devices 100 in a plurality of configurations. As described herein, each solar-powered charging device 100 may include complementary interfaces and/or engagement mechanisms that are configured to selectively attach and detach to one another for assembling multiple solar-powered charging devices 100 in different modular configurations. Solar-powered charging device 100 may include a housing 101 having a generally squared shape defined by a lower (first) wall 103, an upper (second) wall 105, and one or more (third) sidewalls 107 extending between lower wall 103 and upper wall 105.

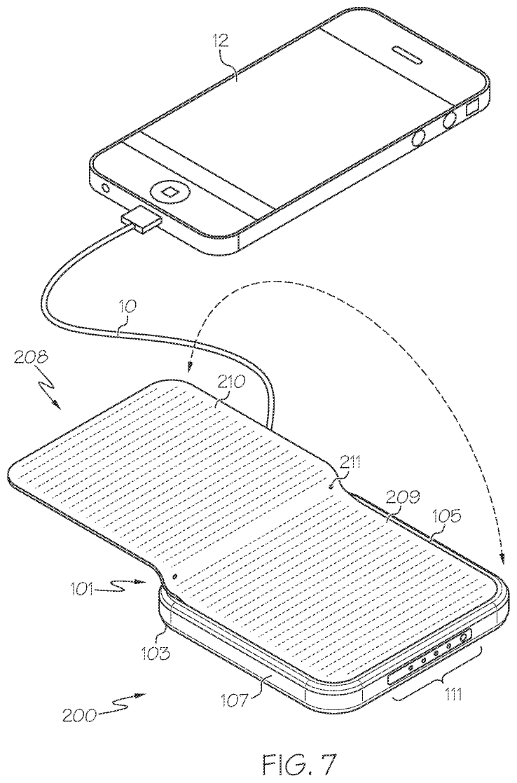

Although shown as having a squared shape, solar-powered charging device 100 may have additional and/or fewer walls, and various other shapes without departing from a scope of this disclosure. By way of example, solar-powered charging device 100 may have a rectangular, a circular, a cylindrical, a triangular, a pentagonal, and various other cross-sectional profiles. In the example, solar-powered charging device 100 may have a substantially uniform cross-sectional dimension along a longitudinal length of housing 101 (e.g., a width and/or height that is equal or substantially equal at opposing ends of housing 101). As shown and described below, a cross-sectional shape and/or dimension of housing 101 may vary in other embodiments (see FIGS. 7-9C).

Still referring to FIGS. 1A-1B, lower wall 103 and upper wall 105 may be positioned to face in opposite directions from one another. Housing 101 may be formed of a polymer or combination of polymer materials, such as durable materials. For example, one or more portions of housing 101 may comprise acrylonitrile butadiene styrene (ABS), polypropylene, polyethylene, polyurethane, including thermoplastic polyurethane (TPU), polyvinylchloride (PVC), plastic, rubber, silicone, or a combination thereof. In one embodiment, housing 101 may be crack-resistant, crack-proof, water-resistant, and/or waterproof. Therefore, solar-powered charging device 100 may be configured for use in various environmental conditions, e.g., suitable for indoor and outdoor use.

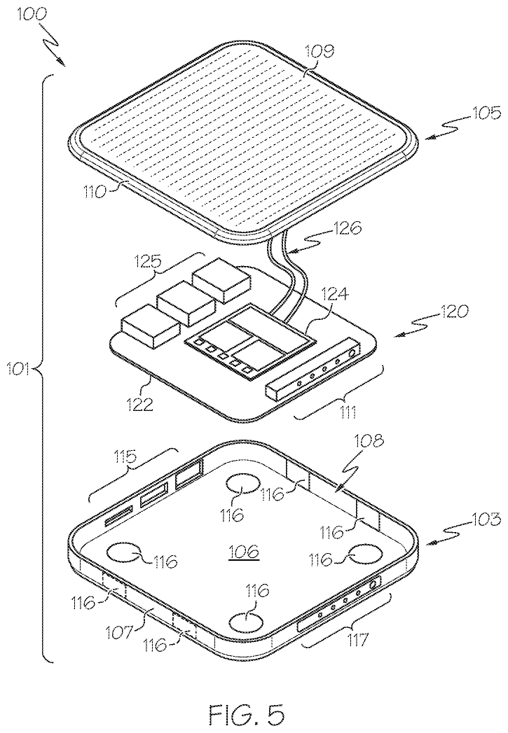

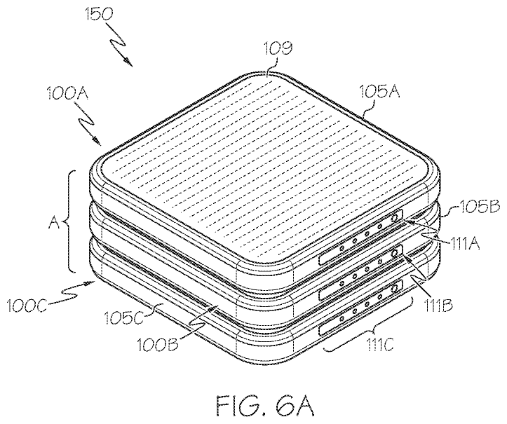

Housing 101 may further include a solar panel 109 positioned along an exterior surface of upper wall 105. In one embodiment, solar panel 109 may be coupled to or integrated into the exterior surface of upper wall 105 to allow for exposure to light (e.g., natural light or artificial light). In another embodiment, solar panel 109 may fit within a recessed area of upper wall 105 to allow for an electronic connection to internal components of solar-powered charging device 100 (FIG. 5). Solar panel 109 may extend along a substantial portion of the external surface of upper wall 105, such as along a longitudinal length and/or a lateral width of upper wall 105. In other embodiments, however, solar panel 109 may have various other suitable sizes and/or shapes relative to the exterior surface of upper wall 105 without departing from a scope of this disclosure.

Still referring to FIG. 1A, solar panel 109 may comprise a plurality of solar cells, regulator chips, and/or resistors to achieve a specific electrical output. For example, when solar panel 109 is energized by light (e.g., natural light or artificial light), the solar cells may produce energy and charge a rechargeable battery 122 of solar-powered charging device 100 (see FIG. 5). Additionally and/or alternatively, the solar cells of solar panel 109 may generate electrical current for powering an external electronic device coupled to solar-powered charging device 100. In further embodiments, solar panel 109 may include a thin solar film built from lightweight and flexible materials (e.g., plastic, silicon, etc.) with substances capable of generating electrical current (e.g., photovoltaic cells) formed on the surface of solar panel 109. Solar panel 109 may comprise silicon, e.g., monocrystalline or polycrystalline silicon. Solar panel 109 may be backed by a support material, such as polycarbonate or another plastic or polymer. In one embodiment, the exterior surface of upper wall 105 may include a protective film or resin disposed over solar panel 109, thereby providing an outer layer on upper wall 105 to protect solar panel 109 against damage and/or exposure to contaminants.

At least one sidewall 107 may include a user interface 111 which may include one or more lights and/or actuators for controlling solar-powered charging device 100. For example, the lights on user interface 111 may provide information to a user, such as a charging status and/or an amount of power remaining in the rechargeable battery 122 of solar-powered charging device 100 (see FIG. 5) and/or of an electronic device coupled thereto. The lights on user interface 11 may further provide information of a mode of operation of solar-powered charging device 100. In one embodiment, user interface 111 may include a plurality of light-emitting diodes (LEDs) that may be operably coupled to rechargeable battery 122. In one embodiment, the plurality of LEDs of user interface 111 may illuminate and/or display different colors based on different charge statuses and/or power levels of solar-powered charging device 100 or of an external electronic device coupled thereto. For example, the LEDs of user interface 111 may be selectively illuminated to provide information as to the amount of power remaining in rechargeable battery 122, e.g. the illumination of fewer indicator lights indicating lower amounts of power. In one embodiment, the power stored in rechargeable battery 122 may cause the LEDs of user interface 111 to operate at various levels of intensity (e.g., low, medium, high, etc.), illumination patterns (e.g., flashing, pulsing, etc.), and colors.

In one embodiment, the plurality of LEDs of user interface 111 may be positioned along at least one sidewall 107, while in other embodiments user interface 111 may be positioned along various other walls and/or surfaces of housing 101 (e.g. lower wall 103, upper wall 105, etc.). The LEDs of user interface 111 may emit various colors of light (e.g., green, red, yellow, white, etc.) to indicate various information, such as, for example, a charging status and/or amount of power remaining in the rechargeable battery of solar-powered charging device 100 and/or the electronic device coupled thereto, or a mode of operation of solar-powered charging device 100.

By way of illustrative example, a green light may indicate a full or minimum threshold charge, a yellow light may indicate an intermediate charge that is less than the full charge, a red light may indicate a low charge, a blue light may indicate an active charging process, and a white light may indicate an active mode of operation of solar-powered charging device 100. User interface 111 may further include one or more actuators (e.g., a button, a touchscreen, a display, a switch, a dial, etc.). In another example, user interface 111 may be configured to illuminate an actuator (e.g., a power button) by emitting various colors of light to indicate a status of solar-powered charging device 100 (e.g., on, off, standby, etc.). The power button may be operable to transfer electrical power stored in rechargeable battery 122 to other electronic components of solar-powered charging device 100 and/or to an external electronic device coupled thereto.

In the embodiment, solar-powered charging device 100 may be relatively lightweight to facilitate portability and modular assembly with one or more other solar-powered charging devices 100. For example, solar-powered charging device 100 may have a total weight of less than 12 ounces (e.g., about 340 grams), less than 10 ounces (e.g., about 283 grams), less than 8 ounces (e.g., about 227 grams), less than 6 ounces (e.g., about 170 grams), or less than 4 ounces (e.g., about 113 grams), or a weight of 3 to 8 ounces, or 2 to 4 ounces. Solar-powered charging device 100 may have a relatively compact cross-sectional profile, such as to facilitate ease in carrying and/or storing solar powered charging device 100. For example, the maximum cross-sectional dimension of solar-powered charging device 100 may be less than or equal to 4 inches, or less than or equal to 3 inches, or less than or equal to 2 inches, e.g., from about 2 to 5 inches. Additionally or alternatively, the height of solar-powered charging device 100 may be less than or equal to 1 inch, less than or equal to 0.5 inches, or less than or equal to 0.2 inches, or from 0.2 to 1 inch.

Referring now to FIG. 1B, at least one sidewall 107 may include one or more ports 115 for facilitating access to one or more corresponding electronic connectors 125 of solar-powered charging device 100 (see FIG. 5). The one or more electronic connectors 125 may be disposed within housing 101, and configured to connect rechargeable battery 122 (FIG. 5) to one or more external electronic devices coupled thereto. In some embodiments, electronic connectors 125 may include electrical contact pins. In the embodiment, solar-powered charging device 100 may include a plurality of ports 115 arranged along the at least one sidewall 107 in a horizontal configuration, however, ports 115 may be arranged in any various other suitable configurations along sidewall 107 and/or the other walls of housing 101 without departing from a scope of this disclosure.

In one embodiment, the one or more electronic connectors 125 may include a universal serial bus (USB) connector that is configured to couple an external electronic device (e.g., a smartphone or other mobile device) to solar-powered charging device 100, such as, for example, via a cable. Electronic connectors 125 may include, but are not limited to, a USB port, a USB C port, a micro-USB port, and more. As described further herein, solar-powered charging device 100 may be configured to provide multidirectional charging such that the rechargeable battery 122 may charge an external electronic device coupled to port 115, and may receive electrical charge by the external electronic device coupled to port 115.

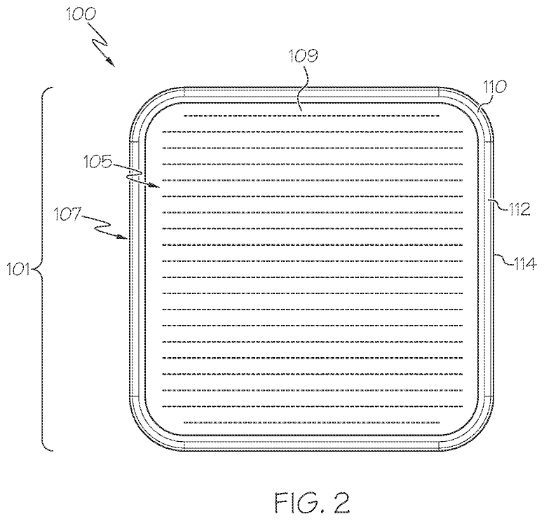

FIG. 2 shows a top view of solar-powered charging device 100, in accordance with some aspects of the present disclosure. Solar panel 109 may cover a substantial portion of upper wall 105 to provide a surface area capable of receiving maximum solar exposure. For example, solar panel 109 may cover less than or equal to 95% of the total surface area of upper wall 105, less than or equal to 85% of the total surface area of upper wall 105, less than or equal to 75% of the total surface area of upper wall 105, or less than or equal to 65% of the total surface area of upper wall 105. It is understood that solar panel 109 may have various suitable sizes and/or shapes relative to the exterior surface of upper wall 105. Upper wall 105 may have rounded corners or edges, however, the corners or edges of upper wall 105 may include other suitable shapes without departing from a scope of this disclosure.

In one embodiment, an outer edge 110 of upper wall 105 may include a first coating 112 and an outer surface of sidewalls 107 may include a second coating 114. Each of the first and second coatings 112, 114 may be configured to increase a frictional-resistance along outer edge 110 and sidewalls 107, respectively, to enhance a grip of solar-powered charging device 100, such as when held by a user. Additionally and/or alternatively, first and second coatings 112, 114 may be configured to provide a protective barrier over outer edge 110 and sidewall 107, respectively, to inhibit damage from physical forces against housing 101 (e.g., impact resistance). First and second coatings 112, 114 may be formed of various suitable materials for enhancing a frictional grip and/or providing a protective barrier on outer edge 110 and the outer surface of sidewalls 107, such as, for example, rubber, silicone, plastic, etc.

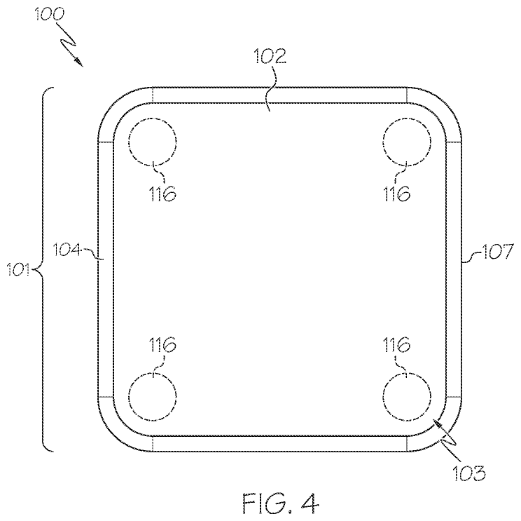

In other embodiments, one or more of the first and second coatings 112, 114 may include a casing, a cover, and/or other material attached to outer edge 110 and/or sidewalls 107, respectively. In another embodiment, outer edge 110 of upper wall 105 and/or the outer surface of sidewalls 107 may include one or more depressions, recesses, and/or cavities sized and shaped to receive an engagement mechanism (e.g. a magnet) for attaching a plurality of solar-powered charging devices 100 to one another. In other embodiments, as shown in FIGS. 4-5 and described further below, solar-powered charging device 100 may include one or more engagement mechanisms (e.g. magnets) disposed within housing 101 such that the outer walls and/or surfaces are devoid of any depressions, recesses, and/or cavities.

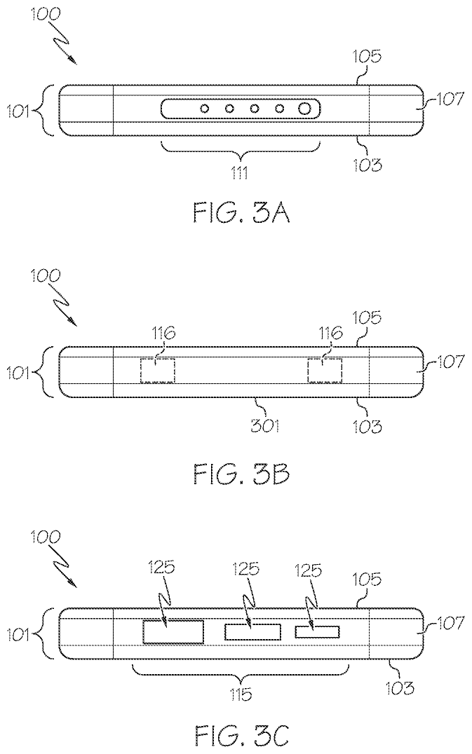

Referring now to FIG. 3A, user interface 111 is depicted in a horizontal configuration relative to at least one sidewall 107. As described above, it should be understood that user interface 111 may be positioned along various other walls and/or surfaces of housing 101, and may be arranged in other suitable configurations without departing from a scope of this disclosure. User interface 111 may include a single LED or a plurality of LEDs, e.g., two, three, four, or more LEDs that are operably coupled to rechargeable battery 122 (see FIG. 5).

FIG. 3B shows at least one sidewall 107 excluding any exterior features thereon (e.g., user interface 111, ports 115, electronic connectors 125). The at least one sidewall 107 may provide a surface to facilitate manual grasping solar-powered charging device 100. In other words, one or more sidewalls 107 may define a surface for grasping by a user to allow for manual control and/or manipulation of housing 101 during use of solar-powered charging device 100. In some embodiments, the one or more sidewalls 107 may have one or more structural features for providing enhanced grip and/or physical protection (e.g., impact resistance) to housing 101. For example, sidewall(s) 107 may include a protrusion, a depression, etc. In one embodiment, sidewall 107 may include a height of less than or equal to 2 inches, less than or equal to 1 inch, less than or equal to 0.5 inches, less than or equal to 0.2 inches, etc.

Sidewalls 107 may further include one or more engagement mechanisms 116 configured to secure housing 101 to a corresponding housing 101 of a second solar-powered charging device 100. Engagement mechanisms 116 may be disposed within housing 101 and positioned along an interior surface of sidewalls 107. In other embodiments, engagement mechanisms 116 may be disposed external to housing 101 and positioned along an exterior surface of sidewalls 107. In the example, engagement mechanisms 116 may include magnets configured to magnetically couple solar-powered charging device 100 to another solar-powered charging device 100. Each sidewall 107 may include one or more engagement mechanisms 116. In the example, the pair of sidewalls 107 excluding user interface 111 and ports 115 may include at least one engagement mechanism 116.

In the example, at least one sidewall 107 may include a pair of engagement mechanisms 116 (e.g. magnets) positioned along the interior surface of sidewall 107 (see FIG. 5). In other embodiments, the one or more of sidewalls 107 including user interface 111 and/or ports 115 may further include at least one engagement mechanism 116. It should be appreciated that a size, a shape, a position, an orientation, and an arrangement of engagement mechanisms 116 may vary from that shown and described herein without departing from a scope of this disclosure. As described in detail below, solar-powered charging device 100 may include additional and/or fewer engagement mechanisms 116 within and/or on housing 101, such as, for example, along one or more of lower wall 103, upper wall 105, outer edge 110, and more.

Referring now to FIG. 3C, at least one sidewall 107 may include three ports 115 to facilitate access to a respective electronic connector 125 disposed therein. In the example, each of the ports 115 may have a different size and/or shape in accordance with the electronic connector 125 coupled thereto. For example, and as described in detail above, electronic connectors 125 may include a USB port, a USB C port, a micro-USB port, and more. Accordingly, each port 115 may be sized in accordance with the type of electronic connector 125 received therein. In another embodiment, housing 101 may include one or more movable covers coupled to ports 115 (not shown) along sidewall 107 for selectively cover ports 115, thereby sealing the respective electronic connector 125. The movable cover(s) may be manually removed to facilitate access to port 115 and allow for the electronic connector 125 to receive an electric cable for coupling an external electronic device to solar-powered charging device 100.

Referring now to FIG. 4, an exterior surface 102 of lower wall 103 may be formed of various suitable materials, including, for example, plastic, rubber, silicone, polymer, or any other materials. Exterior surface 102 may be configured to generate a frictional-resistance along lower wall 103 to enhance a grip of housing 101, such as, for example, against an external surface that solar-powered charging device 100 may be positioned on. In one embodiment, exterior surface 102 may have a smooth and/or planar (e.g., flat) configuration, while in other embodiments exterior surface 102 may include one or more protrusions and/or depressions to provide for enhanced grip and/or impact resistant properties.

In one embodiment, lower wall 103 may include a bumper 104 disposed about an outer edge of exterior surface 102. Bumper 104 may define a raised surface relative to exterior surface 102, and may be configured to increase a frictional-resistance along the outer edge of lower wall 103 and/or provide a protective barrier around exterior surface 102. Bumper 104 may have a predetermined thickness extending around a perimeter of exterior surface 102 for providing a slip-resistant interface along lower wall 103. Bumper 104 may be formed of various suitable materials, including, for example, plastic, rubber, silicone, polymer, and various other suitable materials. Although bumper 104 is shown and described herein as extending along the outer edge of lower wall 103, it should be understood that bumper 104 may be positioned along various other portions and/or surfaces of lower wall 103. Further, bumper 104 may include various suitable shapes and/or sizes.

Still referring to FIG. 4, lower wall 103 may include one or more engagement mechanisms 116 positioned adjacent to exterior surface 102. In the example, engagement mechanisms 116 may be disposed within housing 101, such as along an interior surface of lower wall 103 opposite of exterior surface 102 (see FIG. 5). For example, lower wall 103 may include at least one engagement mechanism 116 (e.g. a magnet) positioned at each corner along the outer edge of exterior surface 102. It should be appreciated that a size, a shape, a position, an orientation, and an arrangement of engagement mechanisms 116 may vary from that shown and described herein without departing from a scope of this disclosure.

FIG. 5 shows an exploded view of solar-powered charging device 100, and specifically one or more internal components of housing 101. For example, solar-powered charging device 100 may include an electrical assembly 120 disposed within housing 101. At least one sidewall 107 may include a plurality of apertures 117 for facilitating access to user interface 111, and at least another sidewall 107 may include a plurality of ports 115 for facilitating access to electronic connectors 125. Lower wall 103 may define a cavity that is sized, shaped, and/or otherwise configured to receive one or more internal components of solar-powered charging device 100, such as electrical assembly 120. Electrical assembly 120 may include rechargeable battery 122, a circuit board 124, the plurality of electronic connectors 125, and user interface 111. Electrical assembly 120 may further include one or more induction coils for wirelessly diffusing electrical power between multiple solar-powered charging devices 100.

In some embodiments, one or more of lower wall 103, upper wall 105, and/or sidewalls 107 may include engagement mechanisms configured to mate with corresponding engagement mechanisms of one or more other solar-powered charging devices 100. For example, an interior surface 106 of lower wall 103 may include a plurality of engagement mechanisms 116 and an interior surface 108 of one or more sidewalls 107 may include a plurality of engagement mechanisms 116. Although not shown, it should be appreciated that additional and/or fewer engagement mechanisms 116 may be positioned along additional and/or fewer surfaces or walls of housing 101 without departing from a scope of this disclosure. Engagement mechanisms 116 may include various suitable devices and/or features for coupling multiple solar-powered charging devices 100 to one another, such as, for example, a magnet, an adhesive, a clip, a clasp, a tab, a hook, a raised or recessed surface, and more.

Still referring to FIG. 5, rechargeable battery 122 may include, but is not limited to, a ferric or lithium-ion battery, a nickel-cadmium battery, a nickel-metal hydride battery, and more. Rechargeable battery 122may be electrically connected to solar panel 109, and may be configured to store solar power collected from solar panel 109 and converted to electrical power. The electrical power stored by rechargeable battery 122 may be used to charge one or more external electronic devices coupled to solar-powered charging device 100, such as, for example, a mobile device, a tablet, a computer, an external battery, and more. In another embodiment, rechargeable battery 122 may comprise a plurality of rechargeable batteries that are coupled together in series within housing 101.

In one embodiment, rechargeable battery 122 may have a capacity ranging from about 100 mAh to about 3500 mAh, e.g., about 1500 mAh to about 3500 mAh, about 2000 mAh to about 3000 mAh, or about 3000 mAh to about 3500 mAh, e.g., about 200 mAh, about 250 mAh, about 300 mAh, about 350 mAh, about 400 mAh, about 450 mAh, about 500 mAh, about 550 mAh, about 600 mAh, about 1000 mAh, about 1500 mAh, about 2000 mAh, about 2500 mAh or about 3000 mAh. According to some examples herein, the capacity of rechargeable battery 122 may be sufficient to recharge a plurality of external devices for at least 4 hours, at least 5 hours, at least 6 hours, or at least 7 hours or more.

Still referring to FIG. 5, circuit board 124 may be electrically coupled to rechargeable battery 122 and to solar panel 109. Circuit board 124 may be positioned on within housing 101, and may be configured to direct the electric power stored in rechargeable battery 122 to an external electronic device coupled to solar-powered charging device 100 (e.g. at electronic connectors 125), to thereby charge a battery of the external electronic device using the solar power collected by solar panel 109.

In one example, housing 101 may include built-in electrical connectors (e.g. within electronic connectors 125) that act as contacts allowing the energy-producing circuitry of solar-powered charging device 100 to be connected to the charging circuitry of the external electronic devices coupled thereto. Solar panel 109 and circuit board 124 may be integrally attached to one another by electrical connectors 126 (e.g. wires), such that circuit board 124 may operate using electrical power converted from the solar power collected by solar panel 109. In instances where an external electronic device is not coupled to solar-powered charging device 100, the solar power collected by solar panel 109 and converted to electrical power may be stored in rechargeable battery 122 for future use.

In one embodiment, circuit board 124 may include control circuitry operable to control solar-powered charging device 100. In another embodiment, circuit board 124 may include a communications circuitry operable to enable communication between solar-powered charging device 100 and a plurality of other solar-powered charging devices 100 and/or external electronic devices coupled thereto using any suitable communications protocol. For example, communications circuitry may support wireless fidelity (Wi-Fi), Bluetooth®, a data network, a wireless network, or any other known communications protocol.

Still referring to FIG. 5, electronic connectors 125 may be electrically coupled to rechargeable battery 122, and configured to direct the electrical power stored in rechargeable battery 122 to the external electronic devices coupled thereto. As described above, electronic connectors 125 may be configured to allow multidirectional charging between rechargeable battery 122 and a battery of the external electronic device(s) coupled thereto. For example, electronic connectors 125 may be configured to direct electrical power from a respective battery of the external electronic device(s) coupled to solar-powered charging device 100 to rechargeable battery 122, for charging rechargeable battery 122. Additionally and/or alternatively, electronic connectors 125 may be configured to direct the electrical power stored in rechargeable battery 122 to the respective battery of the external electronic device(s) coupled to electronic connectors 125.

User interface 111 may be electrically coupled to rechargeable battery 122. As described above, the LEDs of user interface 111 may be configured to display information indicative of a charging status and/or a current charge level of rechargeable battery 122 by emitting light in various intensities, patterns, colors, etc. In further embodiments, the LEDs of user interface 111 may be configured to display information indicative of a charging status and a current charge level of a battery of an external electronic device coupled to solar-powered charging device 100.

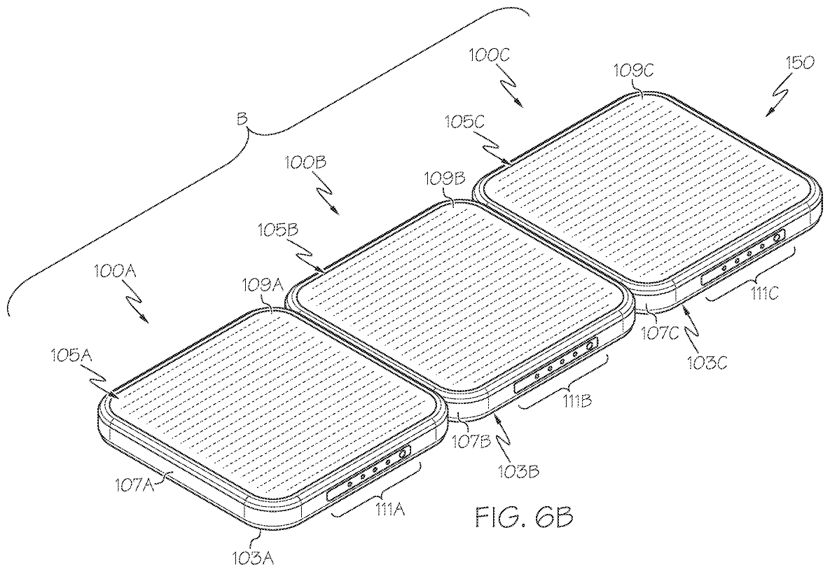

FIG. 6A shows a plurality of solar-powered charging devices 100 coupled to one another in a first (vertical) configuration, in accordance with some aspects of the present disclosure. As mentioned above, solar-powered charging devices 100 may be modular and capable of selectively assembling with one another in a plurality of configurations. Each solar-powered charging device 100 may work independently to collect solar power (e.g. via the respective solar panel 109), store the solar power (e.g. via the respective rechargeable battery 122), and charge an external electronic device coupled thereto (e.g., via the respective electronic connectors 125). In addition, multiple solar-powered charging devices 100 may be physically attached/coupled together to work as a collective charging system. Multiple solar-powered charging devices 100 may be physically attached/coupled to one another in various configurations, e.g., stacked atop one another, coupled side-by-side, assembled in a three-dimensional shape, etc.

In the example shown in FIG. 6A, a first solar-powered charging devices 100A, a second solar-powered charging device 100B, and a third solar-powered charging device 100C may be attached/coupled together in a first (vertically-assembled) configuration A to form a modular charging system 150. The first solar-powered charging device 100A may be positioned above the second solar-powered charging device 100B and the third solar-powered charging device 100C in the first (vertically-assembled) configuration A, such that the solar panel 109 of the first solar-powered charging device 100A may be exposed to light.

In this instance, the solar panel 109 of the first solar-powered charging device 100A may be configured to collect solar power for the entire modular charging system 150. In other words, solar power collected by solar panel 109 of the first solar-powered charging devices 100A may be transferred (e.g. wirelessly) to the second solar-powered charging device 100B and the third solar-powered charging device 100C. Although only three devices 100A, 100B, 100C are shown in modular charging system 150, additional and/or fewer solar-powered charging devices may be included in the first (vertically-assembled) configuration A. As described below, in other configurations and/or arrangements of modular charging system 150 (FIG. 6B), one or more additional solar panels of the other solar-powered charging devices may be exposed to light and capable of collecting solar power for the entire modular charging system 150.

In some embodiments, the first solar-powered charging devices 100A may directly transfer the solar power to each of the second solar-powered charging device 100B and third solar-powered charging device 100C. In other embodiments, the first solar-powered charging devices 100A may directly transfer the solar power to the second solar-powered charging device 100B, which is adjacent to the first solar-powered charging devices 100A relative to the third solar-powered charging device 100C (in the first configuration A). In this instance, the second solar-powered charging device 100B may directly transfer at least a portion of the solar power received from the first solar-powered charging devices 100A to the third solar-powered charging device 100C. Accordingly, the solar power collected by modular charging system 150 may be distributed across multiple solar-powered charging devices.

Still referring to FIG. 6A, modular charging system 150 may be configured to charge at least one external electronic device coupled to each of the solar-powered charging devices 100A, 100B, 100C, and/or charge a respective rechargeable battery of each solar-powered charging device 100A, 100B, 100C. In some embodiments, modular charging system 150 may be configured to distribute the solar power equally and/or simultaneously to each of the plurality of solar-powered charging devices 100A, 100B, 100C communicatively coupled to one another. In other embodiments, modular charging system 150 may distribute the solar power in series and/or in a predefined sequence between the plurality of solar-powered charging devices 100A, 100B, 100C.

For example, the first solar-powered charging device 100A located at the top of the first (vertically-assembled) configuration A may initially charge its respective rechargeable battery 122 via the solar power collected from solar panel 109. Upon completion, additional solar power collected from solar panel 109 may flow between the remaining plurality of solar-powered charging devices 100B, 100C. In another example, the first solar-powered charging device 100A may initially transfer the solar power collected by solar panel 109 to the other solar-powered charging devices 100B, 100C prior to charging its respective rechargeable battery 122.

Such flow of solar power may enable the plurality of solar-powered charging devices 100A, 100B, 100C to charge each other, and/or an external electrical device coupled to any of the devices in modular charging system 150. In this instance, modular charging system 150 may form an electric power grid, such that each of the plurality of solar-powered charging devices 100A, 100B, 100C are configured to share solar power with one another, provide electrical power for charging an external electronic device coupled to any one of the devices 100A, 100B, 100C, and/or serve as a backup power source for one other. By way of illustrative example, an external electrical device may be connected to an electronic connector 125 of at least one of the second solar-powered charging device 100B and/or the third solar-powered charging device 100C, such that the solar power collected from the first solar-powered charging device 100A may charge the external electronic device coupled to the second and/or third solar-powered charging device 100B, 100C.

Modular charging system 150 may be configured to collect additional solar power at an enhanced rate when assembled with the plurality of solar-powered charging devices 100A, 100B, 100C. To minimize an energy load burden on any one solar-powered charging device 100A, 100B, 100C, modular charging system 150 may be configured to distribute the energy load evenly across the plurality of solar-powered charging devices 100A, 100B, 100. When in the assembled state, modular charging system 150 may have an expanded charging capacity relative to each of the individual solar-powered charging devices 100A, 100B, 100C included in modular charging system 150. Modular charging system 150 may define an electric power grid capable of storing large amounts of solar power and charging a plurality of external electronic devices simultaneously. In the embodiment, the plurality of solar-powered charging devices 100A, 100B, 100C may be balanced and attached to one another in the first (vertically-assembled) configuration A by the one or engagement mechanisms 116 respectively housed within the housings 101 of each solar-powered charging device 100A, 100B, 100C.

As described further below, the plurality of solar-powered charging devices 100A, 100B, 100C may be stacked in various suitable directions, orientations, three-dimensional shapes (e.g., square, rectangular, triangular, polygonal, etc.), arrangements and/or alignments. The plurality of solar-powered charging devices 100A, 100B, 100C in modular charging system 150 may wirelessly diffuse solar power between each other via various wireless power transfer mechanisms, such as, for example, through electromagnetic inductive charging via the one or more induction coils disposed within each housing of the plurality of solar-powered charging devices 100A, 100B, 100C.

FIG. 6B shows the plurality of solar-powered charging devices 100A, 100B, 100C coupled together to form modular charging system 150 in a second (horizontally-assembled) configuration B, in accordance with some aspects of the present disclosure. Although solar-powered charging devices 100A, 100B, 100C are coupled side-by-side in a horizontal configuration, it is understood that modular charging system 150 may be arranged in any other configuration. Solar-powered charging devices 100A, 100B, 100C may be attached/coupled together via the one or more engagement mechanisms 116 located on the respective sidewalls 107A, 107B, 107C of each solar-powered charging device 100A, 100B, 100C.

In the second (horizontally-assembled) configuration B, a first solar panel 109A of the first solar-powered charging device 100A, a second solar panel 109B of the second solar-powered charging device 100B, and a third solar panel 109C of the third solar-powered charging device 100C may be simultaneously exposed to light. Accordingly, each of the solar-powered charging devices 100A, 100B, 100C in modular charging system 150 may be configured to individually collect solar power via the respective solar panels 109A, 109B, 109C when in the second (horizontally-assembled) configuration B.

As described in detail above, solar power may flow between the plurality of solar-powered charging devices 100A, 100B, 100C when coupled to one another in the second (horizontally-assembled) configuration B, such as by electromagnetic inductive charging. Such flow of solar power may enable the plurality of solar-powered charging devices 100A, 100B, 100C to charge each other and/or external electronic device coupled to any one of the solar-powered charging devices 100A, 100B, 100C. Modular charging system 150 may form an electric power grid to share solar power collected by the solar panel 109A, 109B, 109C of any one of the solar-powered charging devices 100A, 100B, 100C with one another. The plurality of solar-powered charging devices 100A, 100B, 100C may also wirelessly diffuse solar power between each other via other known wireless power transfer mechanisms. Although first and second configurations are shown in FIGS. 6A-6B, it should be appreciated that a plurality of solar-powered charging devices forming modular charging system 150 may be assembled in various other configurations, including, for example, in arrangements defining three-dimensional objects and/or shapes.

Referring now to FIG. 7, another exemplary solar-powered charging device 200 is depicted. Solar-powered charging device 200 may be configured and operable similar to solar-powered charging device 100 except for the differences explicitly noted herein, such that like reference numerals are used to identify like components. Solar-powered charging device 200 may include an expandable solar panel 208 coupled to housing 101 along upper wall 105. Expandable solar panel 208 may include a first portion 209 and a second portion 210 that may be flexibly expandable relative to first portion 209. In the example, second portion 210 may be configured to move relative to first portion 209 from a first (closed) position, in which second portion 210 is disposed over first portion 209, to a second (opened) position in which second portion 210 is extended outwardly away from first portion 209 and as seen in FIG. 7).

Second portion 210 of expandable solar panel 208 may be secured and movable relative to housing 101 at one or more attachment points 211. Specifically, second portion 210 may be secured to upper wall 105 at the one or more attachment points 211. Accordingly, second portion 210 may be configured to move about the attachment points 211 to expose first portion 209 from underneath second portion 210 when moving from the first (closed) position to the second (opened) position shown in FIG. 7. It should be appreciated that, when in the first (closed) position, second portion 210 may cover first portion 209 such that expandable solar panel 208 may be concealed from light exposure. Accordingly, expandable solar panel 208 may be inhibited from collecting solar panel when in the first (closed) position.

Expandable solar panel 208 may have a bisector fold line between first portion 209 and second portion 210, along which expandable solar panel 208 may expand or fold. Second portion 210 may be folded on top of a surface of first portion 209, such as in an overlapping arrangement, when in the closed position. Further, second portion 210 may be unfolded from first portion 209 and extended in a radially-outward direction, thereby exposing the surface of first portion 209, when in the open position. When in the second (opened) position, first portion 209 and second portion 210 may be arranged side-by-side relative to one another, with the surfaces of each portion 209, 210 exposed to receive light. In one embodiment, the surface area of first portion 209 and second portion 210 may be equal to one another, while in other embodiments the respective surface areas may vary.

In the second (opened) position, expandable solar panel 208 may provide a large surface area for exposure to light (e.g., natural light or artificial light), such that expandable solar panel 208 may be configured to collect greater amounts of solar power from solar-powered charging device 200. In other words, when in the second (opened) position, solar-powered charging device 200 may be configured to receive additional sunlight given the expanded surface area of expandable solar panel 208. In a further embodiment, expandable solar panel 208 may be configured to move to the second (opened) position in response to second portion 210 translating a radially-outward from over first portion 209 until second portion 210 is arranged in a side-by-side configuration with first portion 209. Stated differently, second portion 210 may be configured to slide out from over and/or under first portion 209, thereby exposing the full surface area of expandable solar panel 208. In this instance, at least one of the surfaces of first portion 209 and/or second portion 210, depending on the vertical arrangement of expandable solar panel 208 when in the first (closed) position, may be exposed to light.

In another embodiment, second portion 210 may be selectively coupled to first portion 209, such that second portion 210 may be removed entirely by disengaging second portion 210 from upper wall 105 at the one or more attachment points 211. In further embodiments, second portion 210 may be configured to rotate, swivel, and/or pivot relative to first portion 209 to reposition expandable solar panel 208 in a plurality of orientations. Expandable solar panel 208 may be opened manually, hydraulically, electrically, or by various other suitable methods.

Still referring to FIG. 7, an external electronic device 12 may be connected to solar-powered charging device 200, such as via a cable 10, to electronic connector 125. The external electronic device 12 may be charged while expandable solar panel 208 is in the first (closed) position (e.g. from the electrical power stored in rechargeable battery 122) or the second (opened) position (e.g. from the solar power collected at first portion 209 and second portion 210). Further, the external electronic device 12 may be charged while solar-powered charging device 200 is simultaneously charging rechargeable battery 122 from the solar power collected by first portion 209 and second portion 210.

As described in detail above, solar-powered charging device 200 may be further configured for multi-direction charging, such that the rechargeable battery 122 may receive a charge from the external electronic device 12 coupled thereto via the cable 10. In this instance, rechargeable battery 122 may receive electrical power from a battery of the external electronic device 12, irrespective of a position of expandable solar panel 208.

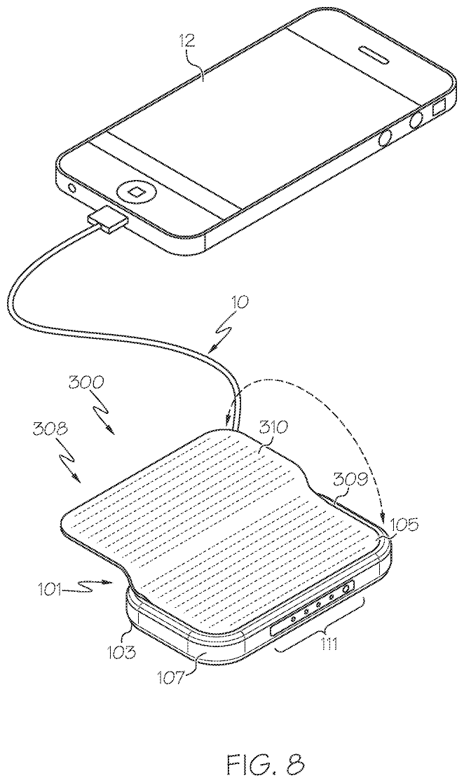

FIG. 8 shows another exemplary solar-powered charging device 300 according to the present disclosure. Solar-powered charging device 300 may be configured and operable similar to solar-powered charging device 200 shown and described above except for the differences explicitly noted herein. Solar-powered charging device 300 may be sized and shaped to have an ergonomic profile to facilitate grasping housing 101 during use of solar-powered charging device 300. For example, housing 101 of solar-powered charging device 300 may have a generally rectangular shape defined by a width that is relatively less than a longitudinal length to accommodate manual control of solar-powered charging device 300 by a hand of a user. In other words, solar-powered charging device 300 may have a slim profile, relative to solar-powered charging devices 100, 200 shown and described above, to enhance a grip of housing 101 by a user. Accordingly, lower wall 103, upper wall 105, and a first portion 309 and a second portion 310 of an expandable solar panel 308 may have a generally rectangular configuration.

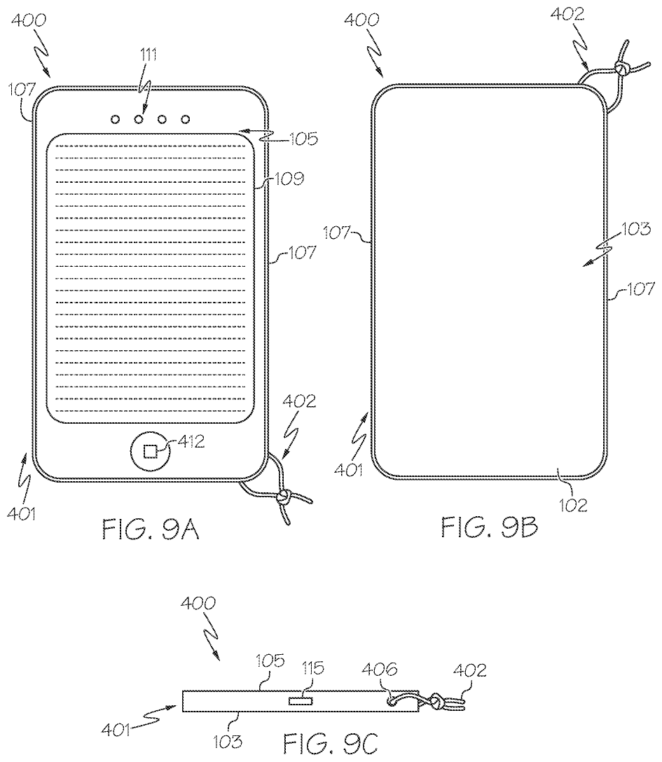

FIGS. 9A-9C show another exemplary solar-powered charging device 400 according to the present disclosure. Solar-powered charging device 400 may be configured and operable similar to solar-powered charging device 100 shown and described above except for the differences explicitly noted herein. Solar-powered charging device 400 may include a housing 401 defined by lower wall 103, upper wall 105, and one or more sidewalls 107. In the example, solar-powered charging device 400 may include user interface 111 on upper wall 105, such as adjacent to solar panel 109. Solar-powered charging device 400 may further include at least one actuator 412 on upper wall 105. Actuator 412 may include a button, a touchscreen display, a switch, a dial, and/or various other suitable input interfaces.

While one actuator 412 is depicted in FIGS. 9A-9C, it should be understood that solar-powered charging device 400 may include additional actuators for controlling various other functions of solar-powered charging device 400. In the embodiment, actuator 412 may include a power button for controlling a power state of solar-powered charging device 400. Actuator 412 may be further configured to display information indicative of a power status of solar-powered charging device 400 and/or a charge level of rechargeable battery 122. For example, actuator 412 may include an LED configured to emit a light indicative of said information. In other embodiments, actuator 412 may be operable to receive a user input for transferring solar power stored in rechargeable battery 122 to an external electronic device coupled thereto, such as at port 115 (see FIG. 9C).

Still referring to FIGS. 9A-9C, solar-powered charging device 400 may further include a handle 402 coupled to housing 401. In the embodiment, handle 402 may be coupled to housing 401 along at least one sidewall 107, and may provide a support member that a user can grasp when carrying solar-powered charging device 400. Alternatively, handle 402 may serve as a hook from which a user can hang solar-powered charging device 400. For example, handle 402 may be attached to an external clip, such as a carabineer, for hanging solar-powered charging device 400.

Handle 402 may have opposing ends attached to sidewall 107, allowing handle 402 to move relative to housing 401. Alternatively, and as seen in FIG. 9C, housing 401 may include an aperture 406 through one or more sidewalls 107 for receiving handle 402. Handle 402 may be flexible or rigid, and may include any various suitable materials including, but not limited to, a pliable polymer, a braided cord, a fiber material (e.g., nylon), a rigid polymer, a metal, a metal alloy, and more. Handle 402 may be fixedly attached to housing 401, or selectively detachable from housing 401. In the embodiment, handle 402 may have a fixed and/or an adjustable length. In other embodiments, handle 402 may include other suitable types of handles, such as a strap, a clip, a screw, a magnet, Velcro, etc.

It is intended that the specification and examples be considered as exemplary only, with a true scope and spirit of the present disclosure being indicated by the following claims.

What is claimed is:

1. A solar-powered charging device, comprising:
a housing;
a rechargeable battery disposed within the housing; and
a solar panel positioned along an exterior of the housing, the solar panel is electrically connected to the rechargeable battery;
wherein the solar panel is configured to generate electrical power and the rechargeable battery is configured to store the generated electrical power to charge an external electronic device electrically connected to the device.

2. The device of claim 1, wherein the device is configured to wirelessly transfer the electrical power generated by the solar panel and stored in the rechargeable battery to a second solar-powered charging device when the housing is positioned adjacent to the second solar-powered charging device.

3. The device of claim 2, further comprising one or more first induction coils disposed within the housing, and one or more second induction coils disposed within a second housing of the second solar-powered charging device;
wherein the electrical power is transferred from the one or more first induction coils as a current and received by the one or more second induction coils.

4. The device of claim 2, further comprising an engagement mechanism disposed within or coupled to the housing, the engagement mechanism is configured to attach the housing to a second housing of the second solar-powered charging device.

5. The device of claim 4, wherein the second solar-powered charging device includes a complementary engagement mechanism disposed within or coupled to the second housing, the engagement mechanism of the device is configured to mate with the complementary engagement mechanism of the second solar-powered charging device to attach the housing to the second housing.

6. The device of claim 5, wherein the engagement mechanism includes at least a first magnet, and the complementary engagement mechanism includes at least a second magnet that is configured to magnetically couple with the first magnet when the second housing is positioned adjacent to the housing.

7. The device of claim 6, wherein the solar-powered charging device and the second solar-powered charging device are cooperatively configured to generate an electric power grid for charging one or more external electronic devices coupled to the solar-powered charging device and the second solar-powered charging device.

8. The device of claim 7, wherein the electric power grid is selectively modular such that the housing of the solar-powered charging device and the second housing of the second solar-powered charging device are cooperatively configured to couple with one another in a plurality of configurations.

9. The device of claim 8, wherein the plurality of configurations includes at least:
a first configuration with the housing of the solar-powered charging device positioned over the second housing of the second solar-powered charging device;
a second configuration with the housing of the solar-powered charging device positioned lateral to the second housing of the second solar-powered charging device; and
a third configuration with the housing of the solar-powered charging device positioned relative the second housing of the second solar-powered charging device to form a three-dimensional arrangement.

10. The device of claim 1, further comprising an electrical connector disposed within the housing, the electrical connector is electrically connected to the rechargeable battery, and configured to electrically connect the rechargeable battery to the external electronic device.

11. The device of claim 10, wherein the device is configured to charge the external electronic device via the electrical connector using the electrical power generated by the solar panel and stored in the rechargeable battery.

12. The device of claim 10, wherein the device is configured to charge the rechargeable battery with the electrical power from the external electronic device electrically connected thereto via the electrical connector.

13. The device of claim 10, wherein the electrical connector is a first electrical connector, and the housing includes a plurality of electrical connectors disposed within the housing and electrically connected to the rechargeable battery, each of the plurality of electrical connectors is configured to receive a different electrical input.

14. The device of claim 13, wherein the device is configured to charge a plurality of external electronic devices electrically connected to the rechargeable battery via the plurality of electrical connectors;
wherein the device is configured to charge the rechargeable battery with electrical power from one or more of the plurality of external electronic devices electrically connected thereto via one of the corresponding plurality of electrical connectors.

15. The device of claim 1, wherein the solar panel is expandable from a first position to a second position, and has a greater surface area when in the second position relative to the first position.

16. A solar-powered charging device, comprising:
a housing;
a rechargeable battery disposed within the housing; and
a solar panel positioned along an exterior of the housing, the solar panel is electrically connected to the rechargeable battery;
wherein the device is configured to transfer electrical power generated by the solar panel and stored in the rechargeable battery to a second solar-powered charging device when the housing is positioned adjacent to the second solar-powered charging device.

17. The device of claim 16, wherein the device is configured to wirelessly transfer electrical power generated by the solar panel and stored in the rechargeable battery to the second solar-powered charging device via one or more induction coils disposed within the housing.

18. The device of claim 16, further comprising an engagement mechanism disposed within or coupled to the housing, the engagement mechanism is configured to attach the housing to a second housing of the second solar-powered charging device.

19. The device of claim 18, wherein the second solar-powered charging device includes a complementary engagement mechanism disposed within or coupled to the second housing, the engagement mechanism of the device is configured to mate with the complementary engagement mechanism of the second solar-powered charging device to attach the housing to the second housing.

20. A solar-powered charging assembly, comprising:
a first device including:
a first rechargeable battery; and
a first solar panel electrically connected to the first rechargeable battery; and
a second device including:
a second rechargeable battery; and
a second solar panel electrically connected to the first rechargeable battery;
wherein the first device is configured to transfer electrical power generated by the first solar panel and stored in the first rechargeable battery to the second rechargeable battery when the first device is positioned adjacent to the second device.
